(19) United States
(12) Patent Application Publication
(10) Pub. No.: US 2002/0118715 A1
(43) Pub. Date: Aug. 29, 2002

(54) Semiconductor laser module and Raman amplifier using the module

(75) Inventors: Toshio Kimura, Tokyo (JP); Yutaka Oki, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 09/984,997

(22) Filed: Nov. 1, 2001

(30) Foreign Application Priority Data
Nov. 2, 2000 (JP) 2000-336269

(51) Int. Cl. H01S 3/04; H01S 3/08

(52) U.S. Cl. 372/36; 372/102; 372/108

(57) ABSTRACT

In a semiconductor laser module of the present invention, an FBG is disposed at the rear of a semiconductor laser device through a lensed fiber to define a cavity between the FBG and the semiconductor laser device. The reflectivity of an antireflection coating on a front end face of the semiconductor laser device is set to 1% or more, and the reflectivity of an antireflection coating on a rear end face of the semiconductor laser device is set to 0.5% or less. An isolator is disposed between a collimating lens and a condenser which are disposed in front of the semiconductor laser device. The FBG is formed in the lensed fiber. Two or more FBGs identical or different in the reflection center wavelength are disposed in the lensed fiber. The full width at half maximum of the FBG is set to 1 to 5 nm, and the reflectivity of the FBG is set to 50% or more. The semiconductor laser module is used in a Raman amplifier.

### BACKGROUND OF THE INVENTION

1. Field of the Invention

The present invention relates to a semiconductor laser module which is capable of being employed as a pumping light source of an optical amplifier, and an optical amplifier which is capable of being employed in optical communication.

2. Description of the Related Art

In existing optical fiber communication systems, there have been frequently employed rare earth doped fiber amplifiers. In particular, there have been more frequently employed an erbium doped optical fiber amplifier to which erbium (Er) has been doped (hereinafter referred to as “EDFA”). The practical gain wavelength band of the EDFA is in a range between about 1530 nm and about 1610 nm. Also, the EDFA has a wavelength dependency, and in the case where the EDFA is used in a wavelength division multiplexing signal light, the gain changes in accordance with the wavelength of the signal light.

In the midst of on-going dense wavelength division multiplexing (DWDM), a Raman amplifier has been increasingly expected as an amplifying system having a broader broadband than that of the EDFA. Upon making an intensive light (pumping light) putted into an optical fiber, the Raman amplification has a peak of the gain at a longer wavelength side (a frequency lower by about 13 THz assuming that the pumping light of 1400 nm band is applied) from the pumping optical wavelength by about 100 nm due to induced Raman scattering. The Raman amplification is an optical signal amplifying method using such a phenomenon that when the signal light having the wavelength band by which the above gain is obtained enters the optical fiber thus excited, the signal light is amplified.

The EDFA has the practical gain wavelength band ranging from about 1530 nm to about 1610 nm whereas the Raman amplification hardly has a limit of the wavelength band (because it is presumed that a range between 1300 and 1650 nm is used in fact, the wavelength band of the pumping light is in a range between 1200 and 1550 nm). If the wavelength of the pumping light putted into the optical fiber changes, the gain appears at a longer wavelength side from the wavelength of the pumping light by a predetermined wavelength, and therefore an amplified gain can be obtained at an arbitrary wavelength. For that reason, according to the wavelength division multiplexing (WDM), the number of channels for the signal lights can be further increased.

The above gain has a gain distribution with a wavelength distribution, for example, a distribution having a width of about 20 nm because glass molecules of which the optical fiber is made have a variety of vibration poses. In order to make the wavelength dependency of the gain flat over the broader wavelength band, the pumping lights of various wavelengths are multiplexed to appropriately adjust the wavelengths, the outputs and soon of the respective pumping lasers. In the Raman amplification, the existing optical fibers for communication can be employed as amplifying medium, and the Raman gain in the case of employing the existing optical fibers is small to the degree of about 3 dB when the pumping light of 100 mW is inputted. For that reason, there is required that an intensive pumping light is obtained by multiplexing. In general, the pumping light from about 500 nW to about 1 W in total is normally obtained by multiplexing.

As the pumping light source used in the Raman amplifier, there is used a semiconductor laser module that stabilizes the wavelengths due to fiber bragg grating (FBG) and outputs a high power light.

One of the semiconductor laser modules with the FBG is shown in FIG. 6. A laser beam emitted from a semiconductor laser device A is converted into a collimated beam through a first lens B, and the collimated beam is condensed onto an input end face of an optical fiber D through a second lens C, to thereby optically couple the semiconductor laser device A with the optical fiber D. The optical fiber D is formed with a fiber grating E that reflects only a light having a predetermined wavelength. In the semiconductor laser module shown in FIG. 6, a Peltier device P for temperature control is disposed within a package F, a base K is disposed on the Peltier device P, and a photodiode (PD) for monitoring, a thermister S and the semiconductor laser device A are mounted on the base K. As shown in FIG. 7, the FBG thus structured has, for example, a reflectivity spectrum whose peak reflectivity is about 4% and whose full width half maximum (FWHM) is 2 nm, and feeds back only a part of the laser beam coupled with the optical fiber D to the semiconductor laser device A. Because a loss of an external resonator made up of the semiconductor laser device A and the FBG becomes smaller at only the center wavelength of the FBG, even in the case where a driving current or an ambient temperature of the semiconductor laser device A changes, the oscillation wavelength of the semiconductor laser device A is fixed at the above center wave.

However, there arises the following problems in employment of the semiconductor laser module with the FBG as shown in FIG. 6 as the pumping light source for the Raman amplifier.

Because the Raman gain is small in the Raman amplification as described above, a high output of the pumping light source is required not only as a total optical output in a state where a plurality of semiconductor laser modules are multiplexed but also as an optical output of a semiconductor laser module single substance.

Moreover, a demand for providing a higher optical output in the semiconductor laser module has been increased year by year from the viewpoints of long-distance transmission and a reduction in the number of optical amplifiers in the optical communication.

In order to meet that demand, there is a method in which the peak reflectivity of the FBG at the front end face side of the semiconductor laser device is lessened in the structure shown in FIG. 6. However, if the peak reflectivity of the FBG is lessened, the lead-in effect of the oscillation wavelength to an FBG predetermined wavelength in the semiconductor laser device is weakened, thereby making it difficult to stabilize the wavelength. As a result, a driving current range of the semiconductor laser device which is available in a state where the wavelength is stabilized is restricted, and the optical output that is available substantially at the maximum is not improved.

As described above, the conventional semiconductor laser module suffers from the difficulty of providing the higher optical output.

### SUMMARY OF THE INVENTION

The present invention has been made to solve the above problems with the conventional device, and therefore an object of the present invention is to provide a semiconductor laser module that is capable of realizing a higher optical output which is suitable for the pumping light source of a Raman amplifier and excellent in a wavelength stability.

In order to achieve the above object, according to a first aspect of the present invention, there is provided a semiconductor laser module comprising: a semiconductor laser device having a cavity length of 800 μm or longer; an optical fiber that receives a laser beam outputted from said semiconductor laser device and transmits the laser beam; wherein a fiber bragg grating (FBG) disposed at the rear of said semiconductor laser device through a lensed fiber and a cavity is defined between said FBG and said semiconductor device. The semiconductor laser module has a collimating lens and a condenser.

According to a second aspect of the present invention, in the semiconductor laser module according to the first aspect of the invention, an antireflection coating having 1% or more reflectivity is formed on a front end face of the semiconductor laser device, and an antireflection coating having less than 1% reflectivity is formed on a rear end face of the semiconductor laser device.

According to a third aspect of the present invention, in the semiconductor laser module according to the first or second aspect of the invention, an antireflection coating having 5% or less reflectivity is formed on a front end face of the semiconductor laser device.

According to a fourth aspect of the present invention, in the semiconductor laser module according to any one of the first to third aspects of the invention, the collimating lens and the condenser are disposed between the font end face of the semiconductor laser device and the optical fiber, and an isolator is disposed between the collimating lens and the condenser.

According to a fifth aspect of the present invention, in the semiconductor laser module according to any one of the first to fourth aspects of the invention, the FBG is formed in the lensed fiber, a rear end face of the lensed fiber is inclined or vertical, and a photodiode (PD) for monitoring is disposed at the rear of the rear end face of the lensed fiber.

According to a sixth aspect of the present invention, in the semiconductor laser module according to any one of the first to fifth aspects of the invention, two or more FBGs are formed in the lensed fiber, and the reflection center wavelengths of the two or more FBGs are identical with or different from each other.

According to a seventh aspect of the present invention, in the semiconductor laser module according to any one of the first to sixth aspects of the invention, the full width at half maximum of the FBG is any one of 1 nm or more and 5 nm or less, and the reflectivity of the FBG is 50% or more.

According to an eighth aspect of the present invention, in the semiconductor laser module according to any one of the first to seventh aspects of the invention, the semiconductor laser device, the lensed fiber with the FBG and the isolator are mounted on a base whose temperature is controlled by a Peltier device.

A Raman amplifier according to the present invention uses the semiconductor laser module as defined in any one of the first to eighth aspects of the invention.

According to the present inventors' study, the following characteristics are required for the semiconductor laser module used as a pumping light source of the Raman amplifier. It is preferable that the semiconductor laser module according to the present invention further satisfies the following required characteristics.

a) A Noise of the Pumping Light is Small:

The noise of the pumping light is −130 dB/Hz or less when an RIN (relative intensity noise) is in a range from 0 to 2 GHz (in a range from 0 to 22 GHz as occasion demands).

b) The Degree of Polarization (DOP) is Small:

It is necessary that a coherent length is short, that is, a multimode is provided and depolarizing is liable to occur, or that no polarization occurs due to polarization multiplexing. The provision of the multimode may be satisfied by making at least three longitudinal modes, preferably four to five longitudinal modes enter within an oscillation spectrum (a width of a wavelength coming down from the peak of the spectrum by 3 dB.

c) The Optical Output is High:

The optical output of the semiconductor laser module is required to be 50 mW or more, preferably 100 mW or more, more preferably 300 mW or more, and most preferably 400 mW or more.

d) The Wavelength Stability is Excellent:

Because a fluctuation of the oscillation wavelength leads to a fluctuation of the gain wavelength band, a technique for stabilizing a lazing wavelength due to a fiber grating, a DFB laser (distributed-feedback laser), a DBR laser (distributed brag reflector laser) or the like is required. It is necessary that the fluctuation width is, for example, within ±1 nm under all of driving conditions (an ambient temperature: 0 to 75° C., a driving current: 0 to 1 A).

e) The Oscillation Spectrums of the Respective Pumping Laser Modules are Narrow:

If the oscillation spectrums of the respective pumping laser modules are too broad, the coupling loss of the wavelength multiplexing coupler becomes large, and the number of longitudinal modes contained within the spectrum width becomes large, as a result of which the longitudinal mode moves during oscillation, and the noise and gain may fluctuate. In order to prevent that drawback, it is necessary to set the oscillation spectrum to 2 nm or less, or 3 mm or less. If the oscillation spectrum is too narrow, a kink appears in the current to optical output characteristic, and a failure may occur in the control during laser driving. If at least three longitudinal modes, preferably four or five longitudinal modes enter in the oscillation spectrum as described in the above item b), it is presumed that the coherency is reduced, thereby being liable to reduce the DOP.

f) The Power Consumption is Low:

Because polarization multiplexing, wavelength multiplexing and so on are applied, a large number of pumping lasers are employed. As a result, the entire power consumption becomes large. It is preferable that the power consumption of the pumping laser module single substance is low.

g) No SBS (Stimulated Brillouin Scattering) Occurs:

When a higher optical output is concentrated in a narrow wavelength band due to the fiber grating or the like, the SBS occurs to deteriorate the pumping efficiency. From this viewpoint, the multimode (a plurality of longitudinal modes exist within the oscillation spectrum) is proper.

h) High PIB (Power In Band):

When lights of plural wavelengths are coupled together, a demand is made to output the laser beam having a relatively narrow linear width of PIB≧90% within the wavelength width 2 nm from the viewpoint of the higher optical output.

i) It is Preferable to Install the Isolator:

In order to prevent the laser operation from being unstabilized due to a reflection light, it is preferable to dispose an isolator within the semiconductor laser module.

### BRIEF DESCRIPTION OF THE DRAWINGS

These and other objects and advantages of this invention will become more fully apparent from the following detailed description taken with the accompanying drawings in which:

FIG. 1 is a side view showing the entire outline of a semiconductor laser module in accordance with the present invention;

FIG. 2 is a detailed explanatory diagram showing an example of the main portion of the semiconductor laser module shown in FIG. 1;

FIG. 3 is a detailed explanatory diagram showing another example of the main portion of the semiconductor laser module shown in FIG. 1;

FIG. 4 is an explanatory diagram showing a Raman amplifier in accordance with an embodiment of the present invention;

FIG. 5 is an explanatory diagram showing a Raman amplifier in accordance with another embodiment of the present invention;

FIG. 6 is an explanatory diagram showing a conventional semiconductor laser module; and

FIG. 7 is an explanatory diagram showing the operation of the semiconductor laser module shown in FIG. 6.

### DETAILED DESCRIPTION

Now, a description will be given in more detail of preferred embodiments of the present invention with reference to the accompanying drawings.

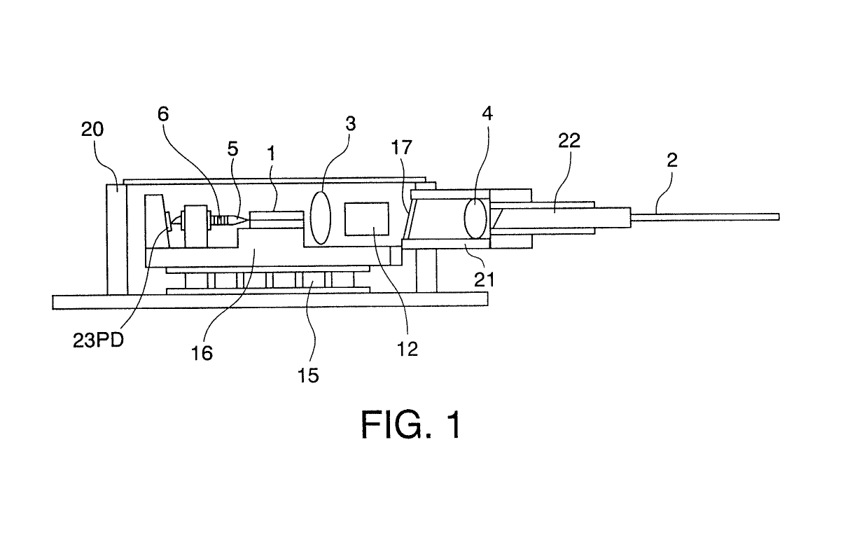

A semiconductor laser module in accordance with a first embodiment of the present invention is shown in FIG. 1. The semiconductor laser module includes a PD 23, a lensed fiber 5 with an FBG, a semiconductor laser device 1, a first lens (collimating lens) 3 which converts a laser beam emitted from the semiconductor laser device 1 into a collimated beam, and an isolator 12 within a package 20. Among those components, the PD 23, the lensed fiber 5 with an FBG, and the semiconductor laser device 1 are mounted on a base 16 whose temperature is controlled by a Peltier device 15. A fitting jig 21 is fitted into the package 20, a second lens (condenser) 4 that condenses the laser beam emitted from the isolator 12 is received within the fitting jig 21, and a ferrule 22 into which an optical fiber 2 is inserted and connected is fixedly inserted into the fitting jig 21. With the above structure, the PD 23, the lensed fiber with an FBG, the semiconductor laser device 1, the collimating lens 3, the isolator 12 and the optical fiber 2 are disposed in a line on an optical axis.

In order to realize the higher optical output as a pumping light source in the Raman amplifier, the semiconductor laser device 1 requires a cavity length of 800 μm or more.

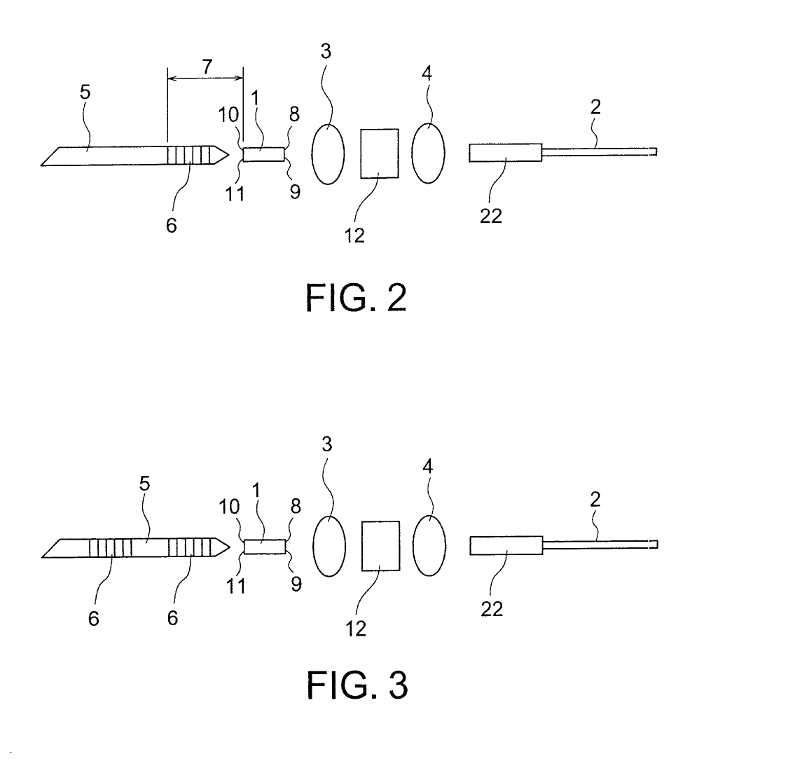

A first embodiment of the components in FIG. 1 is shown in FIG. 2. The lensed fiber 5 shown in FIG. 2 has a front end that has been processed into a lens shape such as a spherical leading shape or a wedge shape so that the fiber per se is converted into a micro lens, and a rear end of the fiber is cut obliquely upward so that reflection is reduced. For example, in the case where the front end of the lensed fiber 5 is wedge-shaped, the front end is provided with a wedge angle corresponding to the astigmatim of the semiconductor laser device 1 so as to enhance the coupling efficiency. An antireflection coating (AR coating) is formed on each of the front end face and the rear end face of the lensed fiber 5, and the reflectivity of those antireflection coatings is desirably set to 0.5% or less (substancially, about 0.1%). An FBG 6 is formed at the front end side of the lensed fiber 5. The FBG 6 is 1 to 5 nm in the full width at half maximum and 50 to 90% in the peak reflectivity. The oscillation wavelength of the semiconductor laser device 1 is locked by the FBG 6. In FIG. 1, a wave selection filter 17 is disposed between the isolator 12 and the condenser 4.

FIG. 2 shows the main portion of the semiconductor laser module shown in FIG. 1.

The rear end face 10 of the semiconductor laser device 1 shown in FIG. 2 is coated with an antireflection coating (AR) 11 whereas the front end face 8 thereof is coated with an antireflection coating (AR coating) 9. A dielectric multilayer coating is suitable for the AR coating. The dielectric multilayer coating may be made of the combination of Ta₂O₅ and SiO₂, TiO₂ and SiO₂, Al₂O₃ and SiO₂, and so on.

The reflectivity of the AR coating 9 on the front end face 8 is set to, for example, 1 to 5%, and the reflectivity of the AR film 11 on the rear end face 10 is set to, for example, less than 1%, preferably 0.5% or less.

In FIG. 2, an external resonator (external cavity) 7 is made up of the FBG 6 and the AR coating 11 of the rear end face 10 of the semiconductor laser device 1, and the FBG 6 and the AR coating 9 on the front end face of the semiconductor laser device 1. The cavity length of the external cavity 7 is adjustable by changing a position of the semiconductor laser device 1 or the FBG 6, and an optical path length between the rear end face 10 of the semiconductor laser device 1 and the FBG 6 is preferably set to 75 mm or less from the viewpoint of a reduction in noise.

The existing components can be employed for the collimating lens 3, the isolator 12 and the condenser 4 shown in FIG. 1, respectively. For example, an aspherical lens, a ball lens, a distributed refractive lens or a plano-convex lens may be employed for the collimating lens 3. Those focal distances f are suitably set to 0.4 to 2 mm (usually f=about 0.7 to 0.8 mm). Antireflection coatings (AR coatings) are formed on both of the front and rear end faces of the collimating lens 3, respectively, and their reflectivity is preferably set to 0.5% or less. Likewise, an aspherical lens, a ball lens, a distributed refractive lens or a plano-convex lens may be employed for the condenser 4. Those focal distances f are suitably set to 1 to 5 mm (usually f=about 3 mm). Antireflection coatings (AR coatings) are formed on both of the front and rear end faces of the condenser 4, respectively, and their reflectivity is preferably set to 0.5% or less. The collimating lens 3 and the condenser 4 are related to the MFD NA of the semiconductor laser device 1 and the MFD -NA of the fiber. The isolator 12 may be of the polarization dependency type.

The optical fiber 2 may be formed of a polarization maintaining fiber (PMF) other than a single mode optical fiber (SMF). In this situation, the polarization is saved by making the polarization maintaining axis (a slow axis or a fast axis) of the PMF coincide with the polarization direction of the laser beam. Also, in order to conduct depolarizing, the polarization maintaining axis of the PMF may be made to coincide with a direction that rotates by 45 degrees with respect to the polarization direction. The input end face (within a ferrule) of the SMF may be so shaped as to be cut vertically or obliquely by 5 to 20 degrees (in fact, 6 to 8 degrees), or shaped into a leading spherical fiber. It is preferable that an antireflection coating 0.5 or less (in fact, 0.1%) in the reflectivity is disposed on the input end face, but the input end face may be kept to be obliquely cut without provision of the antireflection coating.

A lens may be disposed or not disposed in front of the PD 23 shown in FIG. 1. In order to prevent the laser beam inputted onto the photodiode 23 from being reflected and then returned to the interior of the external cavity, it is preferable that the light input face of the PD 23 is inclined with respect to the optical axis.

In the semiconductor laser module of this embodiment, the provision of the FBG 6 makes it possible to stabilize the wavelength and improve the PIB. Also, the reflection spectrum of the FBG 6 is controlled, thereby being capable of realizing a reduction in the SBS and easing a reduction in the DOP.

The FBG 6 is disposed at the rear of the semiconductor laser device 1, and since the peak reflectivity can be set to a high reflectivity of, for example, 50% or more, the lead-in of the oscillation wavelength to the predetermined wavelength in the FBG 6 is sufficient.

Also, when the FBG 6 is thus disposed, and the reflectivity of the AR coating 9 on the front end face 8 of the semiconductor laser device 1 is set to a value lower than, for example, 5% or less, a high optical output can be obtained in the semiconductor laser module.

Likewise, with the provision of the FBG 6 at the rear of the semiconductor laser device 1, the isolator 12 can be disposed between the front end face 8 of the semiconductor laser device 1 and the light input end face of the optical fiber 2.

The isolator 12 may be of the polarization dependent type because the laser beam which has not yet been inputted to the optical fiber 2 is linear polarization whose polarization plane is determined in a constant direction. The isolator of the polarization dependent type can be inexpensive and low in the optical loss as compared with the isolator of the polarization independent type. The optical loss of the typical polarization independent type isolator is about 1 dB whereas the optical loss of the polarization dependent type is about 0.3 dB.

The application of the lensed fiber makes it possible to shorten a distance between the semiconductor laser device 1 and the FBG 6, thereby improving a noise characteristic in a predetermined frequency range.

(Second Embodiment)

A second embodiment of the components shown in FIG. 1 is shown in FIG. 3. In FIG. 3, a semiconductor laser device 1, a first lens (collimating lens) 3 that converts a laser beam emitted from the semiconductor laser device 1 into a collimated beam, an isolator 12, a second lens (condenser) 4, a ferrule 22 and an optical fiber 2 are identical in structure with those in FIG. 2, and the lensed fiber 5 in FIG. 3 is different from that in FIG. 2.

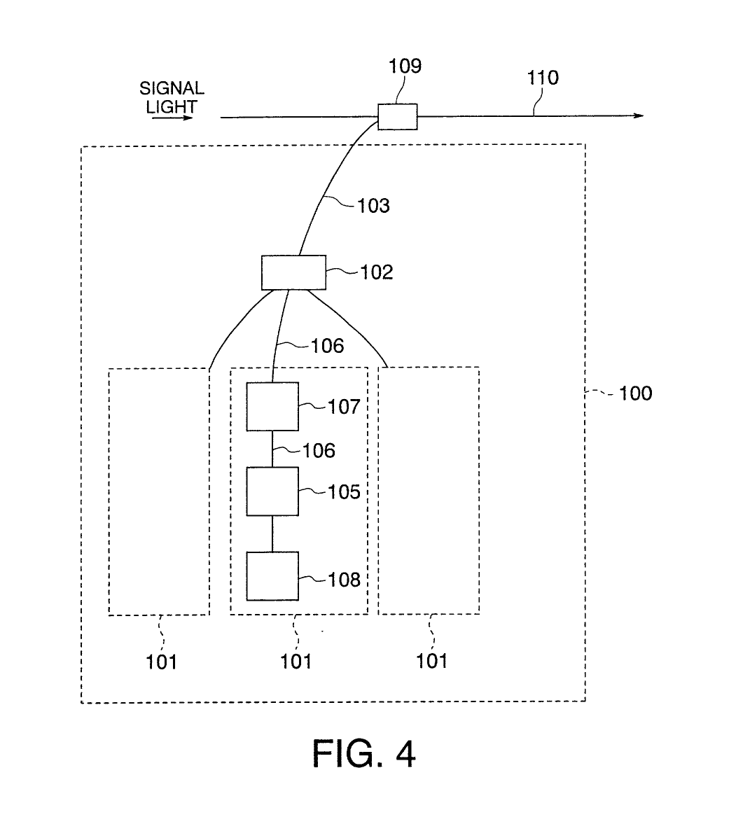

Two FBGs 6 are formed on the lensed fiber 5 shown in FIG. 3. The provision of those two FBGs 6 can more stabilize the wavelength of a light outputted from the semiconductor laser module. Those two FBGs 6 may be identical in the reflection center wavelength with each other, or slightly different in the reflection center wavelength from each other. FIG. 4 shows the structure of an embodiment of a Raman amplifier 100 using the semiconductor laser module described in the above-mentioned respective embodiments as a pumping light source module. The Raman amplifier shown in FIG. 4 is directed to an optical amplifier of a co-pumping method including a plurality of laser units 101 that output lights different in wavelength, a WDM coupler 102 that wavelength-multiplexes the lights outputted from the laser units 101, and an optical fiber 103 that transmits the wavelength-multiplexed light.

Each of the laser units 101 includes the semiconductor laser module 105 described in any one of the above-mentioned respective embodiments, an optical fiber 106 that transmits the laser beam outputted from the semiconductor laser module 105, a depolarizer 107 formed of a PMF inserted into the optical fiber 106, and a control section 108.

The semiconductor laser module 105 outputs the laser beams different in wavelength from each other on the basis of the operation control of the semiconductor laser device by the control section 108, for example, the control of an inrush current or a Peltier module temperature. An isolator of the polarization dependent type is disposed within the semiconductor laser module 105 as in FIGS. 1 to 3, to thereby prevent the reflection light to the semiconductor laser device.

The depolarizer 107 is directed to, for example, a polarization maintaining fiber disposed in at least a part of the optical fiber 106, and its coherent axis is inclined by 45 degrees with respect to the polarization plane of the laser beam outputted from the semiconductor laser module 105. With this arrangement, the DOP of the laser beam outputted from the semiconductor laser module 105 is reduced, thereby being capable of making depolarization.

In the Raman amplifier 100 thus structured, after the DOP of the laser beam outputted from each of the semiconductor laser modules 105 has been reduced by the depolarizer 107, the laser beams different in wavelength are combined together by the WDM coupler 102, and then inputted into the optical fiber 110 through which a signal light is transmitted, through the optical fiber 103 and the WDM coupler 109.

The signal light within the optical fiber 110 is transmitted while being Raman-amplified by the inputted laser beam (pumping light).

In the Raman amplifier 100 of the present invention, the use of the semiconductor laser module 105 and the laser unit 101 according to the present invention makes it possible to obtain the Raman gain excellent in the wavelength stabilization and high in the optical level.

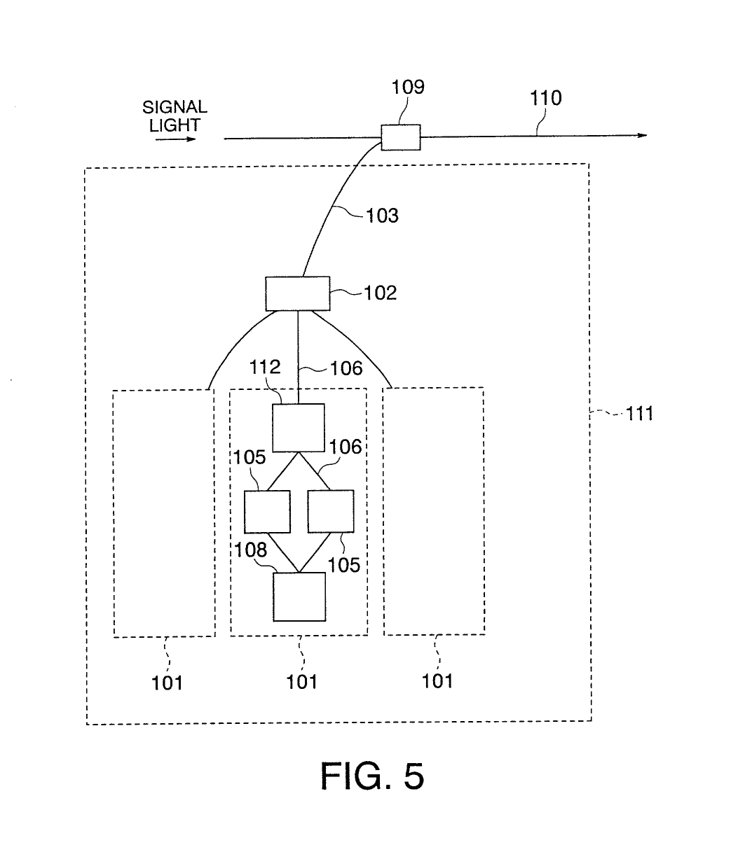

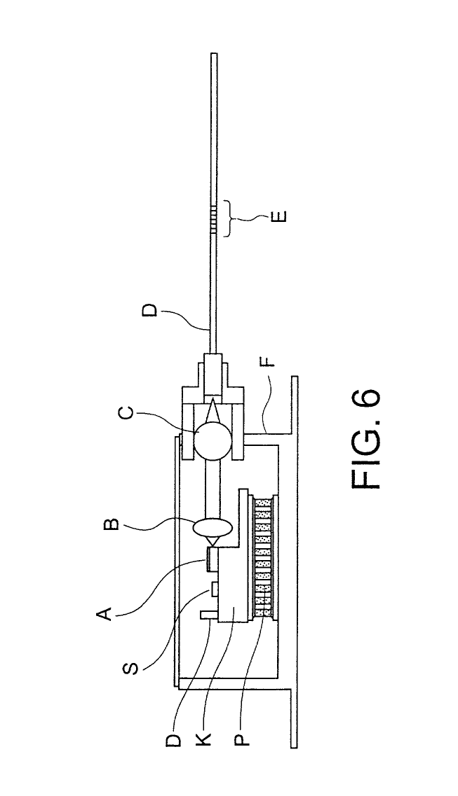

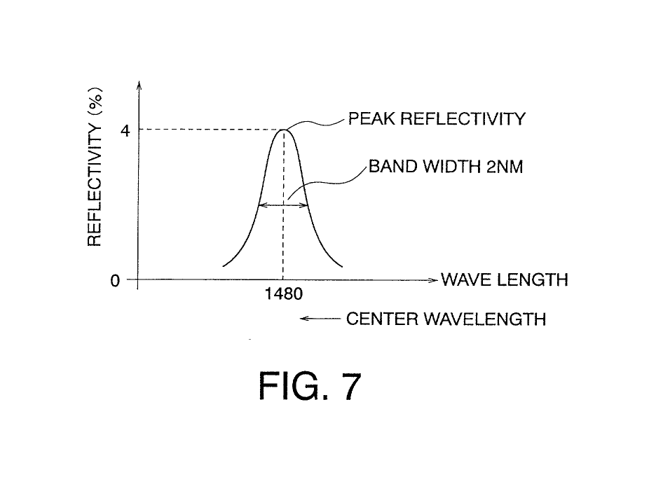

FIG. 5 shows the structure of another embodiment of the Raman amplifier 100 using the above-mentioned semiconductor laser module as the pumping light source module. In FIG. 5, the Raman amplifier 111 is directed to an optical amplifier of the co-pumping method including a plurality of laser units 101 that output lights different in wavelength, a WDM coupler 102 that wavelength-multiplexes the lights outputted from the laser units 101, and an optical fiber 103 that transmits the wavelength-multiplexed lights.

Each of the laser units 101 includes the two semiconductor laser modules 105 described in any one of the above-mentioned respective embodiments, optical fibers 106 that transmits the laser beams outputted from the semiconductor laser modules 105, respectively, a PBC (polarization beam combiner) 112 that polarization-combines those laser beams, an optical fiber that transmits the combined light, and a control section 108 that forms a control means of the present invention.

The above-mentioned plurality of semiconductor laser modules 105 output the laser beams different in wavelength from each other on the basis of the operation control of the semiconductor laser device by the control section 108, for example, the control of an inrush current or a Peltier module temperature. An isolator of the polarization dependent type is disposed within each of the semiconductor laser modules 105 as in FIGS. 1 to 3, to thereby prevent the reflection light to the semiconductor laser device.

After the polarizations of the laser beams outputted from each of the semiconductor laser modules 105 of the Raman amplifier 111, which are identical in the wavelength and different in the polarization plane, have been combined by the PBC 112 and the degree of polarization has been reduced, the lights different in the wavelength are further combined by the WDM coupler 102, and then inputted into the optical fiber 110 through which the signal light is transmitted, through the optical fiber 103 and the WDM coupler 109.

The signal light within the optical fiber 110 is transmitted while being Raman-amplified by the inputted laser beam (pumping light).

In the Raman amplifier 111 of the present invention, the use of the semiconductor laser modules 105 and the laser unit 101 according to the present invention makes it possible to obtain the Raman gain excellent in the wavelength stabilization and high in the optical level.

The present invention is not limited to the abovementioned embodiments, but can be variously modified within the subject matter of the present invention.

Also, in the above-mentioned respective embodiments, the description was given of the Raman amplifier of the co-pumping method by which the present invention can be particularly suitably employed. However, the present invention is not limited to this, but can be applied to the Raman amplifier of the rearward pumping method or the bi-directional pumping method.

### EFFECTS OF THE INVENTION

As was described above, the semiconductor laser module according to the present invention can realize the higher optical output which is suitable for the pumping light source of the Raman amplifier and excellent in the wavelength stabilization.

Also, in the semiconductor laser module according to the present invention, since the isolator is disposed between the semiconductor laser device and the input end face of the optical fiber, the reflection light is prevented, the laser oscillation is stabilized, the loss is less than that of an in-line, and higher output is enabled.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A semiconductor laser module comprising:
a semiconductor laser device whose cavity length is 800 μm or longer;
an optical fiber that receives a laser beam outputted from said semiconductor laser device and transmits the laser beam; and
wherein a fiber bragg grating (FBG) is disposed at the rear of said semiconductor laser device through a lensed fiber and an external cavity is defined between said FBG and said semiconductor laser device.

2. The semiconductor laser module as claimed in claim 1, wherein an antireflection coating having 1% or more reflectivity is formed on a front end face of the semiconductor laser device, and an antireflection coating having less than 1% reflectivity is formed on a rear end face of the semiconductor laser device.

3. The semiconductor laser module as claimed in claim 1, wherein an antireflection coating having 5% or less reflectivity is formed on a front end face of the semiconductor laser device.

4. The semiconductor laser module as claimed in claim 1, wherein an isolator is disposed between a front end face of the semiconductor laser device and the optical fiber.

5. The semiconductor laser module as claimed in claim 1, wherein the FBG is formed in the lensed fiber, a rear end face of the lensed fiber is inclined face or vertical face, and a photodiode (PD) for monitoring is disposed at the rear of the rear end face of the lensed fiber.

6. The semiconductor laser module as claimed in claim 2, wherein the FBG is formed in the lensed fiber, a rear end face of the lensed fiber is inclined face or vertical face, and a photodiode (PD) for monitoring is disposed at the rear of the rear end face of the lensed fiber.

7. The semiconductor laser module as claimed in claim 3, wherein the FBG is formed in the lensed fiber, a rear end face of the lensed fiber is inclined face or vertical face, and a photodiode (PD) for monitoring is disposed at the rear of this rear end face of the lensed fiber.

8. The semiconductor laser module as claimed in claim 1, wherein two or more FBGs are formed in the lensed fiber, and the reflection center wavelengths of the two or more FBGs are identical with or different from each other.

9. The semiconductor laser module as claimed in claim 1, wherein the full width at half maximum of the FBG is any one of 1 nm or more and 5 nm or less, and the reflectivity of the FBG is 50% or more.

10. The semiconductor laser module as claimed in claim 1, wherein the semiconductor laser device, the lensed fiber with the FBG and the isolator are mounted on a base whose temperature is controlled by a Peltier device.

11. A Raman amplifier using the semiconductor laser module as claimed in any one of claims 1 to 10 as a pumping light source.
